(19) United States
(12) Patent Application Publication
(10) Pub. No.: US 2004/0215445 A1
(43) Pub. Date: Oct. 28, 2004

(54) Pronunciation evaluation system

(76) Inventor: Akitoshi Kojima, Utsunomiya-shi (JP)

Correspondence Address: LACKENBACH SIEGEL, LLP, LACKENBACH SIEGEL BUILDING, 1 CHASE ROAD, SCARSDALE, NY, 10583, US

(21) Appl. No.: 09/856,393

(22) Filed: May 22, 2001

Related U.S. Application Data
(63) Continuation of application No. PCT/JP99/05257, filed on Sep. 27, 1999.

(51) Int. Cl. G06F 17/27

(52) U.S. Cl. 704/9

(57) ABSTRACT

Database stores reference voice data for beginner's, intermediate and advance levels. Text in lesson screen displayed on CRT is selected, reference voice data corresponding to this text is read out and model pronunciation is generated. User listens to this, and imitates pronunciation. Computer obtains voice data through the spectrum analysis of the user voice by voice recognition unit and determines user pronunciation level. Predetermined success mark is displayed on screen, if user pronunciation is so good that it is communicated exactly to collocutor. If determination result is bad, practice is repeated for the same text many times. This allows user to judge if his/her pronunciation is recognized by foreigner and improve foreign language pronunciation learning effect, by repeating this practice.

### CROSS-REFERENCE TO RELATED APPLICATIONS

This is a Continuation Application of PCT Application No. PCT/JP99/05257, filed Sep. 27, 1999, which was not published under PCT Article 21(2) in English.

### BACKGROUND OF THE INVENTION

The present invention relates to a pronunciation judgment system using a voice recognition function for language pronunciation practice of foreign language or the like including especially English conversation, and a recording medium for storing a computer program thereof.

Conventionally, a number of language learning systems for practicing English conversation or the like have been developed. A typical system is an interaction with a computer. Here, the computer becomes one speaker, displays the face of a collocutor on the screen, and asks questions to which a user responds. This user response voice is input to the computer and recognized. Then, when it agrees with the correct answer contents, a person representing the collocutor on the screen nods, or other predetermined display is executed, it proceeds to the next question in a way to continue the conversation.

However, this system requires to examine also the content of the response; hence the system is not appropriate for a simple pronunciation repeat practice. In short, when the response content is not correct, the conversation does not continue, in this case, the user can not determine whether the content itself was wrong or his/her pronunciation was wrong. In addition, the user can not concentrate his/her attention to the pronunciation practice, worrying about giving a correct answer. Further, the agreement with the correct answer content is determined by the comparison with a single kind of reference voice data representing the answer content and the determination is fixed; therefore, when the content agrees and only the pronunciation disagrees, the user can not know how wrong was his/her pronunciation and, hence, can not realize to which extent his/her pronunciation is understood by a foreigner. In addition, if the reference voice data level is too high, the user can not pass although he/she tries many times, loosing possibly his/her motivation.

It is an object of the present invention is to provide a pronunciation judgment system allowing to know objectively to what extent one's pronunciation is recognized by the collocutor, and a recording medium for storing a computer program thereof.

Another object of the present invention to provide a pronunciation judgment system allowing to practice the pronunciation effectively through a repeated pronunciation practice of the same text, and display of the degree of similarity to the reference pronunciation, each time, and a recording medium for storing a computer program thereof.

### BRIEF SUMMARY OF THE INVENTION

The pronunciation judgment system of the present invention comprises a database for storing reference pronunciation data, reference voice playback means for outputting the reference voice based on the reference pronunciation data, similarity determination means for comparing a user pronunciation data input in correspondence to the reference voice and the reference pronunciation data, and means for informing the user of the agreement, if the similarity determination means judges the agreement of both data.

In a preferred embodiment, the database may store a plurality of reference pronunciation data corresponding to the pronunciation fluency level, for the same language. The reference voice playback means may include a user operation member for selecting the level and output the selected level reference voice, until the informing means informs the user the agreement of both data. The database may store reference pronunciation data of a plurality of level for each of a number of sentences, while the reference voice playback means may include a user operation member for selecting sentences and the level and output the selected level reference voice of the selected sentence, until the informing means informs the user the agreement of both data. It may further include means for displaying a sentence corresponding to the reference pronunciation data.

The computer readable recording medium for recording a program to be executed by a computer of the present invention records a computer program for executing by a computer steps of reading out the reference voice data from the database, playing back reference voice based on the read out reference voice data, judging the similarity by comparing the user pronunciation data input in correspondence to the reference voice data and the reference voice data, and informing the user of the agreement of both data if such agreement is determined by the similarity determination step.

In a preferred embodiment, the database may store a plurality of reference pronunciation data corresponding to the pronunciation fluency level, for the same language. The reference voice playback step may output the user selected level reference voice, until the informing step informs the user of the agreement of both data. The database may store reference pronunciation data of a plurality of level for each of a number of sentences, while the reference voice playback step may output the user selected level reference voice of the user selected sentence, until the informing step informs the user of the agreement of both data. The program may execute a step of displaying a sentence corresponding to the reference pronunciation data by the computer.

The present invention allows to judge if one's pronunciation attains the level to be recognized by the collocutor, and improve the language learning (pronunciation learning) efficiency, by repeating this practice.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a configuration of the pronunciation judgement system according to present invention;

FIG. 2 is a flow chart showing the flow during the pronunciation practice according to the present invention; and

FIG. 3 shows an example of lesson screen.

### DETAILED DESCRIPTION OF THE INVENTION

Now, the embodiment of pronunciation judgment system of the present invention will de described.

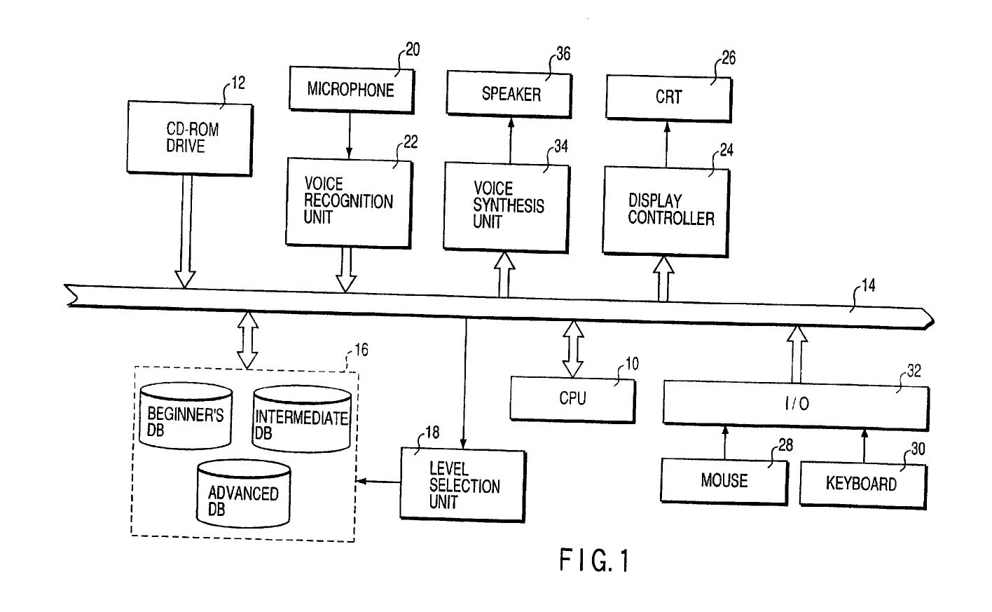

FIG. 1 is a block diagram showing a configuration of the whole system. A CPU 10, a CD-ROM drive 12 are connected to a system bus 14. This system is realized by executing a computer program stored in the CD-ROM drive 12 by the CPU 10. A database 16 for storing reference pronunciation data serving as model of pronunciation practice, for the respective beginner's, intermediate and advanced levels and a level selection unit 18 for selecting the level of the database 16 are also connected to the system bus 14. The database 16 is constructed by collecting pronunciation signal (waveform signal) of a great number of individuals (several hundreds of thousand) and averaging pronunciation data of spectrum analysis thereof. Here, the database 16 is included in the pronunciation practice program, and it may be contained in a CD-ROM and taken in the system, each time. The beginner's level corresponds to the pronunciation of a Japanese teacher of English, the advanced level to the pronunciation of a fluent European and American speaker, and the intermediate level to the pronunciation of a European and American speaker who does not speak so fluently. The database is not necessarily divided into three physical units, but it may only be divided functionally.

A microphone 20 for inputting the voice waveform pronounced by a user is connected to the system bus 14 through a voice recognition unit 22. The voice recognition unit 22 obtains the pronunciation data through spectrum analysis of input voice waveform. This voice recognition unit 22 should perform the same spectrum analysis as used for obtaining the pronunciation data of the database. A CRT 26 is connected to the system bus 14 through a display controller 24, and a mouse 28 and a keyboard 30 are connected through an I/O 32 and, also, a speaker 36 is connected through a voice synthesis unit 34.

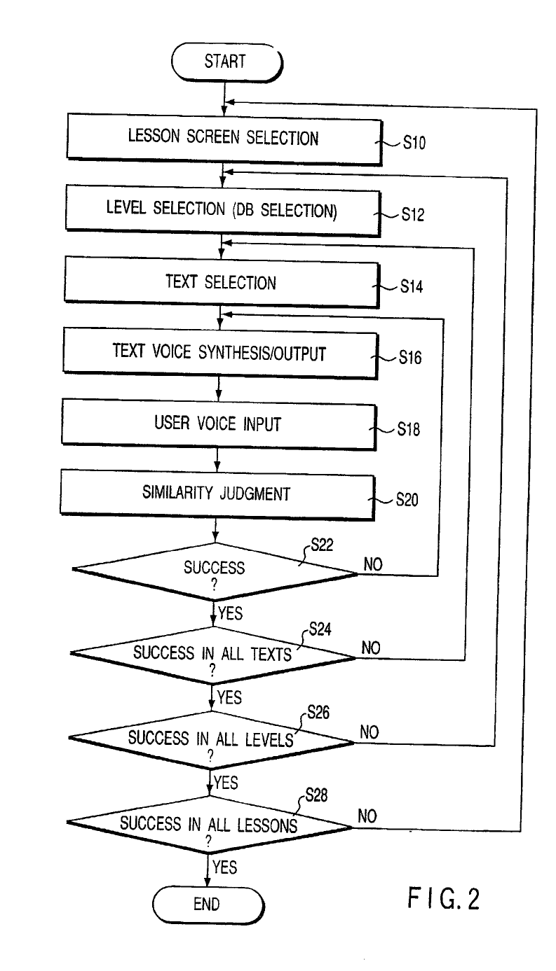

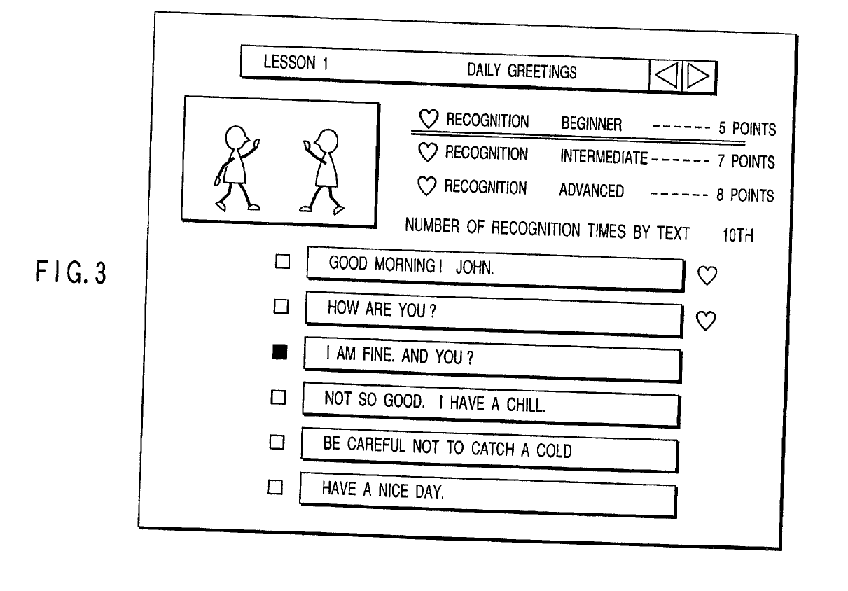

Now, the operation of the present embodiment will be described referring to the flow chart shown in FIG. 2. This flow chart shows the processing flow of computer program performed by the CPU 10 and stored in the CD-ROM 12. Upon starting the operation, a lesson screen shown in FIG. 3 is displayed. This embodiment is supposed to be based on, for example, English textbook for junior high school, and be a pronunciation practice system of texts included in the textbook. The lesson screen comprises a lesson chapter display section 50, an image display section 52 related to the lesson chapter 52, a text display section 54, a pronunciation level display section 56, and a display section 58 showing the number of times of practice per text. The lesson chapter display section 50 displays right and left triangular icons, allowing to select a lesson chapter by operating them with the mouse 28. The text display section 54 shows a plurality of texts, and a square icon showing the text selection state at the left of each text, and a heart mark icon showing a good pronunciation level determination result as the right are displayed. The heart mark icon is a success mark to be displayed a student can pronounce similarly to the model pronunciation (divided into three levels). The level display section 56 displays also the note (out of 10) for the respective level; however, this note is nothing but a standard for indicating the difficulty of respective levels. In the example of FIG. 3, the beginner's level is selected.

In step S10, the lesson chapter is selected. In step S12, the level is selected. The level is selected by selecting any level line with mouse. Here, the beginner's level is selected. In step S14, the text is selected. In the example of FIG. 3, the third “I am fine. And you?” is selected.

In step S16, the beginner's level reference pronunciation data of this selected text is read out from the database 16, the voice is synthesized at the voice synthesis unit 34 and output from the speaker 36 as model pronunciation. The model pronunciation may be output not only once but several times, and the output speed may be varied for several output.

In step S18, the user pronounces imitating this model voice. The user voice waveform is input into the voice recognition unit 22 through the microphone 20. The voice recognition unit 22 obtains the pronunciation data through the spectrum analysis of this voice signal.

In step S20, the user pronunciation data and the reference voice data stored in the database 16 are compared to obtain the similarity degree. The higher this similarity is, the closer the user pronunciation is to the reference voice, showing that the user speaks well, and one's pronunciation has a higher possibility to be communicated exactly to the collocutor and recognized correctly.

In step S22, it is determined whether this similarity is higher than a predetermined similarity, or whether this text pronunciation has obtained the passing mark and succeeded. If the passing mark is not obtained, it goes back to step S16, again, the same text reference voice is output from the speaker 36, and the user repeats the pronunciation practice.

If one text is passed, in step S24, it is determined whether all texts of a chapter are passed or not. If there is any text that is not passed, it goes back to step S14, another text is selected, and the user repeats the pronunciation practice.

If all texts are passed, in step S26, it is determined whether all levels are passed. If there is any level that has not been passed, it goes back to step S12, another level is selected, and the user repeats the pronunciation practice for all texts of the concerned level.

If all levels are passed, in step S28, it is determined whether the other chapters are also passed. If there is any chapter that has not been passed, it goes back to step S10, another chapter is selected, and the user repeats the pronunciation practice for all texts, all levels of the concerned chapter.

As described above, in the present embodiment, the text is displayed and the reference voice is pronounced using a computer, while the student imitates this pronunciation and input from the microphone 20. Then, in the computer, the similarity between the reference voice data and the student input voice data is determined, and if the similarity is lower than a predetermined value, it makes the student repeat the pronunciation practice, and when it is becomes higher than the predetermined value, a success mark is displayed. Thus, the pronunciation practice can be repeated as desired effectively, because the pronunciation practice can be repeated as desired for the same text, and pronunciation level determination result is displayed each time. In addition, the reference voice data is not limited to one kind, but three kinds including the beginner's level pronunciation data which is the pronunciation of a Japanese teacher, the advanced level pronunciation data which is the pronunciation of a particularly fluent native speaker, and the intermediate level pronunciation data which is the pronunciation of a foreign speaker who does not speak so fluently, thereby allowing to improve the pronunciation gradually from the beginner's level to the advanced level through the intermediate level, avoiding a case where the user can not succeed although he/she tries many times because the level is too high, and preventing him/her from losing the motivation.

The present invention in not limited to the embodiment mentioned above, but various modifications can be executed. For example, the essential configuration of the lesson screen has only to have the success mark and the other displays are arbitrary at all. Further, in addition to displaying only the success mark, the similarity to the reference voice may be scored, even in case of failure. Here, the reference pronunciation and the user pronunciation are conducted alternately; however, it is preferable to make the user pronounce at the same time as hearing the reference pronunciation. In the reference voice database, not average data of voice data of number of persons (data after spectrum analysis), but the voice wave form of a particular speaker can be stored as it is. In this case, the voice synthesis unit 34 at the front stage of the speaker 36 is not necessary. In place, it is necessary to submit the voice waveform signal read out from the database to the spectrum analysis by the voice recognition unit 22 as the user input voice signal from the microphone, and to compare with the user input voice data. The object of practice is not limited to English and may include Chinese or the like, and it is not limited to foreign languages, but may include Japanese (National language) or the like. In addition, the corresponding Japanese may be displayed at the same time under the English text display. Further, in place of providing database for respective three levels, but it may be so constructed to use a single database, allowing to change only the level. It will be enough to have the repeated practice effects for the present invention, and it is not always necessary to divide the reference pronunciation into a plurality of levels.

As mentioned above, the present invention allows to provide a pronunciation judgment system capable of determining whether one's pronunciation is recognized by the collocutor, and a recording medium for storing a computer program thereof. In addition, the present invention can provide a pronunciation judgment system allowing to practice the pronunciation effectively through a repeated pronunciation practice of the same text, and to practice the pronunciation effectively alone until the a predetermined similarity level is obtained by comparing, each time, with the reference voice, determining whether it agrees with the reference and displaying how it resembles to the reference pronunciation, and a recording medium storing the a computer program thereof.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A pronunciation judgment system comprising:
a database for storing a plurality of reference pronunciation data of a sentence of the same language and corresponding to a plurality of pronunciation fluency levels for the sentence;
a user operative member for selecting one of same plurality of pronunciation fluency levels;
reference voice playback means for outputting a reference voice based on said reference pronunciation data of the sentence and corresponding to the selected pronunciation fluency level;
similarity determination means for comparing a user pronunciation data input in correspondence to said reference voice and said reference pronunciation data corresponding to the selected pronunciation fluency level; and
means for informing a user of a result of a determination made by said similarity determination means.

2. (canceled)

3. The pronunciation judgment system according to claim 1, wherein said reference voice playback means outputs the reference voice based on said reference pronunciation data of the sentence and corresponding to the selected pronunciation fluency level until said similarity determination means detects agreement of both data.

4. The pronunciation judgment system according to claim 1, wherein said database stores reference pronunciation data of a plurality of sentences of the same language and corresponding to a plurality of pronunciation fluency levels for the sentences, and said reference voice playback means includes a second user operative member for selecting one of the sentences and outputs the reference voice based on said reference pronunciation data of the selected sentence and corresponding to the selected pronunciation fluency level, until said similarity determination means detects agreement of both data.

5. The pronunciation judgment system according to claim 1, further comprising means for displaying the sentence corresponding to the reference pronunciation data.

6. The pronunciation judgment system according to claim 5, wherein said informing means comprises means for displaying an agreement indicator indicating that the similarity determination means detects the agreement of both data.

7. A computer readable recording medium for storing a program for causing a computer to execute the steps of:
reading out reference voice data from a database consisting of a plurality of reference pronunciation data of a sentence of the same language and corresponding to a plurality of pronunciation fluency levels for the sentence;
outputting a user operative member for selecting one of said plurality of pronunciation fluency levels;
playing back a reference voice based on said read out reference voice pronunciation data of the sentence and corresponding to the selected pronunciation fluency level;
determining a similarity by comparing user pronunciation data input in correspondence to said reference voice and said reference voice data corresponding to the selected pronunciation fluency level; and
informing a user of a result of determination made by said similarity determination means.

8. (canceled)

9. The recording medium according to claim 7, wherein said reference voice playback step outputs a user selected level reference voice based on said reference pronunciation data of the sentence and corresponding to the selected pronunciation fluency level, until said similarity determination step detects agreement of both data.

10. The recording medium according to claim 7, wherein said database stores reference pronunciation data of a plurality of sentences of the same language and corresponding to a plurality of pronunciation fluency levels for the sentences, and said reference voice playback step includes a second user operative member for selecting one of the sentences, and said reference voice playback step outputs a user selected reference voice of a user selected sentence and pronunciation fluency level of the selected sentence based on said reference pronunciation data and corresponding to the selected pronunciation fluency levels until said similarity determination step detects agreement of both data.

11. The recording medium according to claim 7, wherein said program causes a computer to execute also a step for displaying the sentence corresponding to the reference pronunciation data.

12. The recording medium according to claim 7, wherein said informing step comprises a step involving the display of an agreement indicator indicating that the similarity determination means detects the agreement of both data.

13. The pronunciation judgment system according to claim 4, further comprising means for displaying some sentences and a selection indicator adjacent to the selected sentence and wherein said informing means comprises means for displaying an agreement indicator indicating that the similarity determination means detects the agreement of both data.

14. The recording medium according to claim 7, further causing the computer to execute the step of displaying some sentences and a selection indicator adjacent to the selected sentence and wherein said informing step displays an agreement indicator indicating that the similarity determination steps detect the agreement of both data. that the similarity determination means detects the agreement of both data.

14. The recording medium according to claim 7, further causing the computer to execute the step of displaying some sentences and a selection indicator adjacent to the selected sentence and wherein said informing step displays an agreement indicator indicating that the similarity determination steps detect the agreement of both data.
